(19) United States
(12) Patent Application Publication
(10) Pub. No.: US 2025/0206148 A1
(43) Pub. Date: Jun. 26, 2025

(54) SIMULATED CLUTCH FOR ELECTRIC VEHICLE

(71) Applicant: StaCyc, LLC, Fort Worth, TX (US)

(72) Inventor: Robert Ryan Ragland, Brock, TX (US)

(21) Appl. No.: 18/999,263

(22) Filed: Dec. 23, 2024

Related U.S. Application Data
(60) Provisional application No. 63/613,873, filed on Dec. 22, 2023.

(51) Int. Cl. B60L 15/20; B62K 23/06; B62M 7/00

(52) U.S. Cl. CPC B60L 15/20; B60L 2200/12; B60L 2240/42; B60L 2250/24; B62K 23/06; B62M 7/00

(57) ABSTRACT

Methods and systems for providing a simulated clutch function for an electric vehicle. One system includes a clutch input mechanism, one or more sensors providing signals representing a position of the clutch input mechanism, and a controller. The controller is configured to determine, based on the signals from the one or more sensors, whether the clutch input mechanism has been released from an engaged state, and, in response to determining that the clutch input mechanism has been released from the engaged state, the controller is configured to (i) determine a clutch multiplier, (ii) determine a clutch delivery time, and (iii) adjust a power curve mapping the position of a throttle mechanism to a power output based on the clutch multiplier and control power to a motor based on a position of a throttle input mechanism and the adjusted power curve for the clutch delivery time.

### RELATED APPLICATIONS

This application claims priority to U.S. Provisional Application No. 63/613,873, filed Dec. 22, 2023, the entire contents of which are incorporated by reference herein.

### FIELD

Examples described herein generally relate to providing a simulated clutch for an electric vehicle, such as, for example, an electric motorcycle.

### SUMMARY

During operation of internal combustion engine (ICE) vehicles, such as, for example, in motocross racing or riding on dirt or other terrains with motorcycles, the clutch may be used as a tool for managing power delivery and performance of the engine. For example, on ICE vehicles, the clutch allows for controlled power delivery from the engine to the transmission and ultimately to the wheels. By modulating the clutch, riders can ensure an appropriate amount of power is delivered to maintain traction, especially on loose or slippery surfaces (e.g., common in motocross). Similarly, at take-off (e.g., at a start of a race), riders may modulate the clutch to prevent excessive wheel spin and ensure a good launch. By controlling clutch release, riders can manage power delivery to get a better start. In addition, smooth gear shifting may be used to maintain momentum and the clutch is instrumental in such shifting. For example, by disengaging the clutch momentarily, riders can shift gears smoothly without upsetting the balance of the motorcycle or losing speed.

When descending or slowing down, riders can also use the clutch in an ICE motorcycle to manage engine braking, which helps control the speed of the motorcycle without relying on the brakes. Skilled riders may also use the clutch to control power delivery during cornering, such as, for example, to maintain traction and exit corners with maximum speed. Feathering the clutch in corners can help keep the engine in an optimal power band. In addition, the clutch on an ICE vehicle may be used to prevent the engine from stalling during low-speed maneuvers or when making mistakes like coming into a corner too fast or needing to slow down rapidly. Experienced riders may also use a technique called “clutch slipping” where the clutch is partially engaged to keep the engine RPM high for better power delivery, especially while exiting a corner or tackling steep inclines. Further still, by slipping the clutch riders can keep the engine RPM within a power band to ensure that maximum power is available when needed. The clutch in ICE vehicles, therefore, is not just a mechanical drive for changing gears, but is a dynamic tool in the hands of a skilled rider that provides a means to control the vehicle's performance and handling characteristics, which may be especially important in the demanding and varied conditions encountered in motocross.

The clutch in ICE vehicles can also be used for safety maneuvers. A “whiskey throttle” is a term used in the motocross and off-road driving community to describe a situation where a rider loses control over the throttle, causing the throttle to stick in the open position or the rider grips it tighter in a panic reaction, leading to unintended acceleration. The clutch can be used to prevent or mitigate whiskey throttle. For example, engaging the clutch disengages the engine from the transmission, effectively cutting off power to the rear wheel. In a whiskey throttle situation, pulling in the clutch (i.e., engaging the clutch) can instantly stop the acceleration, giving the rider a chance to regain control. As noted above, a rider can modulate the clutch to control the power delivery to the wheel, which can be used to recover from a whiskey throttle event and allow the rider to gently re-engage power and regain control. Also, in the panic of a whiskey throttle event, a rider may abruptly close the throttle, which can cause the engine to stall, especially at lower speeds. Similarly, if a rider hits a bump or other object or unexpected terrain while driving, the vehicle may jerk in a way that the throttle lever or input is in a different position in the rider's hand, which can create a whiskey throttle event. Accordingly, using the clutch, a rider can prevent stalling and maintain the engine in an idle state and control over the vehicle. Practicing the use of the clutch in high-stress or high-speed situations can also prepare riders to react appropriately in the event of whiskey throttle. Training muscle memory to engage the clutch can be a lifesaver in such scenarios. Similarly, knowing that the clutch is available as a tool to regain control can reduce a rider's panic reaction in a whiskey throttle situation. Reduced panic can lead to better decision making and vehicle operation.

Accordingly, the clutch on an ICE vehicle serves as an important tool for managing and recovering from whiskey throttle situations and other vehicle operating conditions, in both recreational, competitive, and standard riding environments. Thus, to mimic such clutch functions, examples described herein provide a simulated clutch for an electric motorcycle. For example, an input mechanism mounted on a motorcycle is activable by a rider to simulate a clutch function. As described herein, the input mechanism may be a dual-function (hand) brake and simulated clutch input mechanism or may include separate input mechanisms (e.g., levers) for these functions. In either embodiment, these input mechanism(s) introduce a simulated clutch experience on the electric motorcycle, which may mimic the power modulation and delivery dynamics of an ICE motorcycle.

### BRIEF DESCRIPTION OF THE DRAWINGS

To better understand the invention and to see how the same may be carried out in practice, non-limiting preferred embodiments of the invention will now be described with reference to the accompanying drawings, in which:

FIG. 1 is a perspective view of a motorcycle according to some aspects.

FIG. 2 is a close-up view of a handlebar and a clutch input mechanism of the motorcycle of FIG. 1, according to some aspects.

FIG. 3 is a perspective view of the clutch input mechanism of FIG. 2, according to some aspects.

FIG. 4 is a section view of the clutch input mechanism of FIG. 3, according to some aspects.

FIG. 5 is an exploded view of the clutch input mechanism of FIG. 3, according to some aspects.

FIG. 6A is a top view of the clutch input mechanism of FIG. 3 in a first position, according to some aspects.

FIG. 6B is a close-up top view of the clutch input mechanism of FIG. 3 in a first position, according to some aspects.

FIG. 7A is a top view of the clutch input mechanism of FIG. 3 in a second position, according to some aspects.

FIG. 7B is a close-up top view of the clutch input mechanism of FIG. 3 in a second position, according to some aspects.

FIG. 8A is a top view of the clutch input mechanism of FIG. 3 in a third position, according to some aspects.

FIG. 8B is a close-up top view of the clutch input mechanism of FIG. 3 in a third position, according to some aspects.

FIG. 9 schematically illustrates an electronic speed control unit of the motorcycle of FIG. 1, according to some aspects.

FIG. 10 is a flowchart illustrating a method for controlling operation of an electric motor in response to activation of a clutch input mechanism, according to some aspects.

FIG. 11 is a chart illustrating examples clutch release rates, according to some aspects.

FIG. 12A is a chart illustrating another example of a clutch release rate, according to some aspects.

FIG. 12B is a chart illustrating another example of a clutch release rate, according to some aspects.

FIG. 13 is a chart illustrating a clutch multiplier based on a level of clutch engagement and a clutch engagement time, according to some aspects.

FIG. 14 is a chart illustrating example motor acceleration curves based on the examples shown in FIG. 11, according to some aspects.

FIG. 15 is a chart illustrating example motor acceleration curves based on the examples shown in FIG. 12A and 12B, according to some aspects.

### DETAILED DESCRIPTION

One or more aspects are described and illustrated in the following description and accompanying drawings. These aspects are not limited to the specific details provided herein and may be modified in various ways. Furthermore, other aspects may exist that are not described herein. Also, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way but may also be configured in ways that are not listed. Furthermore, some examples described herein may include one or more electronic control units or controllers. It will be appreciated that these electronic control units or controllers may be comprised of one or more generic or specialized electronic processors, such as, for example, microprocessors, digital signal processors, customized processors, and field programmable gate arrays (FPGAs) and unique stored program instructions (including both software and firmware) that control the one or more electronic control units or controllers to implement the functionality described herein.

Similarly, aspects described herein may be implemented as non-transitory, computer-readable medium storing instructions executable by one or more electronic processors to perform the described functionality. As used in the present application, “non-transitory computer-readable medium” comprises all computer-readable media but does not consist of a transitory, propagating signal. Accordingly, non-transitory computer-readable medium may include, for example, a ROM (Read Only Memory), a RAM (Random Access Memory), register memory, a processor cache, or any combination thereof.

In addition, the phraseology and terminology used herein is for the purpose of description and should not be regarded as limiting. For example, the use of “including,” “containing,” “comprising,” “having,” and variations thereof herein is meant to encompass the items listed thereafter and equivalents thereof as well as additional items. The terms “connected” and “coupled” are used broadly and encompass both direct and indirect connecting and coupling. Further, “connected” and “coupled” are not restricted to physical or mechanical connections or couplings and can include electrical connections or couplings, whether direct or indirect. Moreover, relational terms such as first and second, top and bottom, and the like may be used herein solely to distinguish one entity or action from another entity or action without necessarily requiring or implying any actual such relationship or order between such entities or actions.

As described above, aspects described herein provide systems and methods for controlling the speed and acceleration of an electric motorcycle (also referred to as a “bike”). While aspects are described herein with respect to an electric bike, the components and associated functionality described herein are not limited to electric bikes but can be used in any type of vehicle (for example, a moped, an electric motorcycle, a three-wheeled vehicle, a passenger vehicle, a semi-truck, and the like).

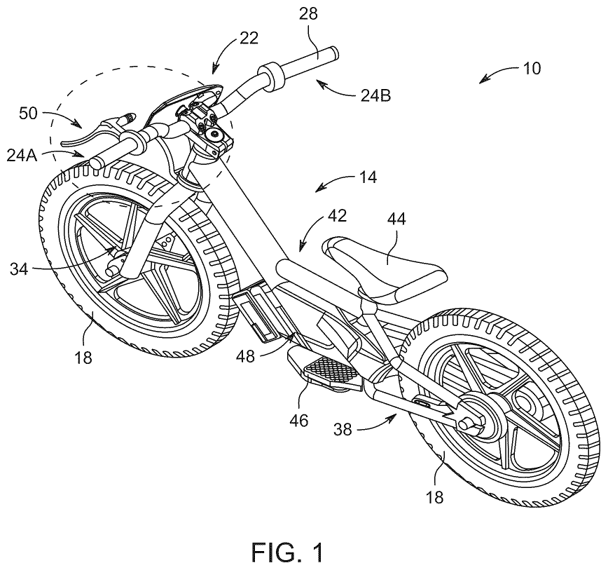

FIG. 1 illustrates a perspective view of an electric motorcycle 10. The electric motorcycle 10 comprises a frame 14, a plurality of wheels 18, and a pair of handlebars 22. The frame 14 forms the structure of the motorcycle 10 and comprises a front fork 34, a rear fork 38, and a central frame 42. The front fork 34 is configured to hold one of the plurality of wheels 18 and is coupled to the handlebars 22 for co-rotation. The rear fork 38 is configured to hold another one of the plurality of wheels 18 and remains in line with the remainder of the frame 14. The central frame 42 is coupled to a seat 44 and the footrest 46, which are both used to position portions of a rider's body. Additionally, the motorcycle 10 includes an electric motor (not shown), an electronic control unit (ECU) 200 (also referred to herein as a controller), a sound system (not shown), and a battery (not shown). In some embodiments, the electric motor, the ECU 200, the sound system, the battery, or a combination thereof may be included in an electronics housing 48 included in the central frame 42. In one embodiment, the electric motor is coupled to one of the plurality of wheels 18 through a sprocket and chain system and is configured to propel the electric motorcycle 10 as instructed by control signals received from the ECU 200.

As shown in FIG. 1, the handlebars 22 includes a left portion 24A and a right portion 24B. In the illustrated embodiment, the right portion 24B of the handlebars 22 includes a throttle input mechanism 28 actuatable (e.g., rotatable) by the rider. The rotation of the throttle input mechanism 28 is measured by a throttle sensor (e.g., a potentiometer or a rotary encoder) and generates a proportional throttle signal. The throttle signal is communicated to the ECU 200, which at least partially determines the power provided to the electric motor based on the received throttle signal.

As also shown in FIG. 1, a clutch input mechanism 50 (also referred to herein as a “clutch lever” or simply a “clutch”) is attached to the handlebars 22, such as, for example, adjacent to the left portion 24A. However, in other embodiments, the clutch input mechanism 50 may be mounted on the right portion 24B of the handlebars 22 or on another surface of the motorcycle 10.

In some embodiments, the throttle input mechanism 28 and the clutch input mechanism 50 may influence an audio output of the sound system, which may include one or more speakers, amplifiers, or the like configured to output audio data. For example, based on the throttle signal received from the throttle sensor, the sound system may output a recorded sound of an engine revving at a proportional volume. Similarly, when the rider actuates the clutch input mechanism 50, the sound system may output a sound similar to that of an engine revving at proportionally decreasing volume. When neither the throttle input mechanism 28 nor the clutch input mechanism 50 is actuated, the sound system may output a sound similar to that of an idling engine of an ICE motorcycle. In another example, the outputted sounds may mimic sounds from a motorcycle that is involved in an actual racing start. In this embodiment, the rider may first engage the clutch input mechanism 50, which causes the sound system to correspondingly produces a simulated revving engine sound. Then, the rider may quickly release the clutch input mechanism 50, and, in response, the sound system may correspondingly produce a high acceleration racing start sound. In other embodiments, this arrangement and operation of the clutch input mechanism 50 and the sound system may be employed on standard motorcycles, such as, for example ICE motorcycles.

In addition or as an alternative to influencing the sound system, in some embodiments, when a rider grasps and pulls the clutch input mechanism 50 (e.g., a lever of such mechanism 50) toward the handlebars 22, power may be proportionally reduced electronically to a drivetrain (e.g., the electric motor) to mimic a response of using a clutch on an ICE motorcycle. Similarly, as the rider releases the clutch input mechanism 50, power may be proportionally increased electronically to the drivetrain to simulate a power boost associated with releasing a clutch on an ICE motorcycle.

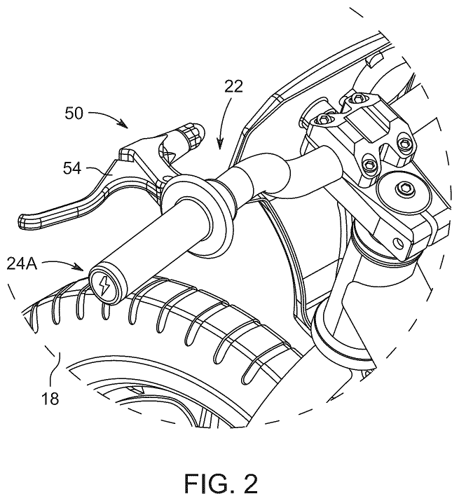

For example, as shown in FIG. 2, in some embodiments, the right portion 24B of the handlebars 22 includes the clutch input mechanism 50. In some examples, the clutch input mechanism 50 operates as a dual-function input mechanism wherein, when actuated, the ECU 200 (or a separate control unit) is configured to either engage a braking system (not shown) or simulate a clutch engagement by proportionally reducing power output by the electric motor to mimic a response of using a clutch on an ICE motorcycle (also known as the simulated clutch function or simulated clutch engagement). For example, the degree of actuation of the clutch input mechanism 50 (e.g., as detected by lever sensor 106) is communicated to the ECU 200, which is configured to use the degree of actuation to simulate a clutch function as described herein. In other examples, as also described herein, a dedicated clutch input mechanism may be used that is separate from a braking input mechanism (e.g., a hand brake lever, a foot brake pedal or button, or the like).

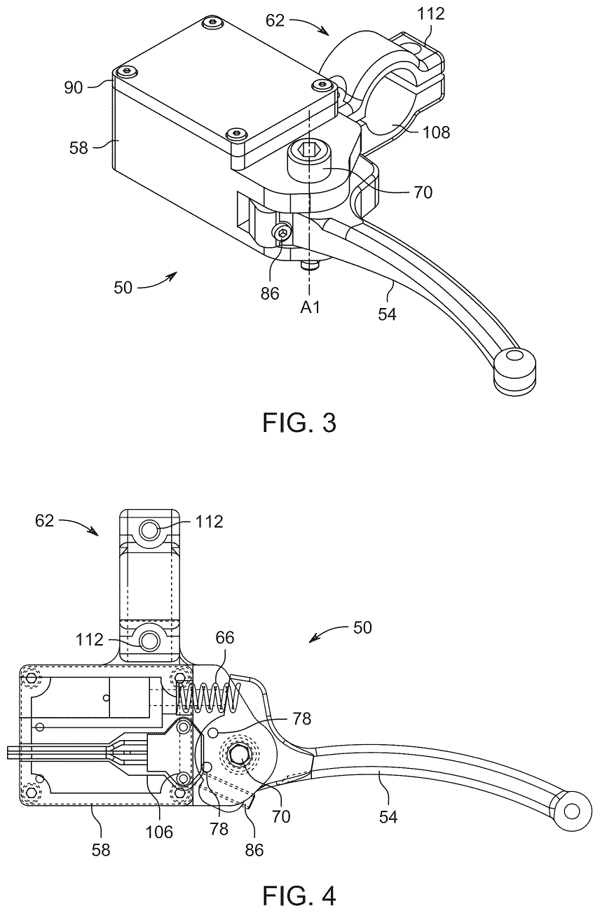

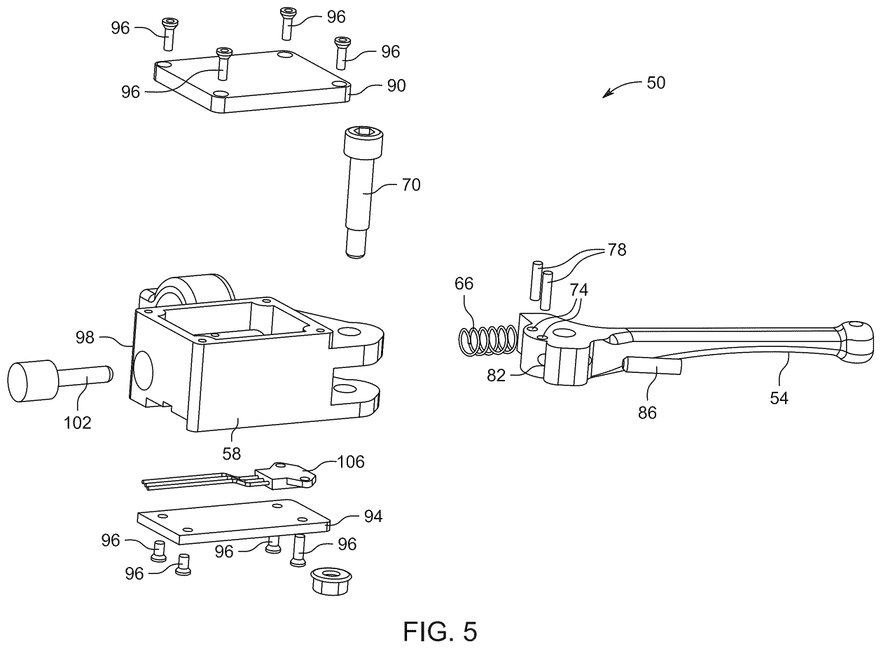

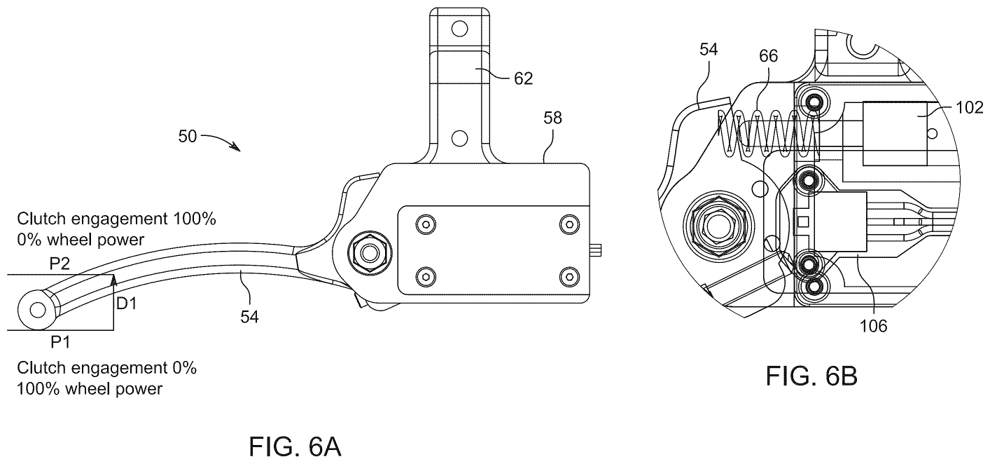

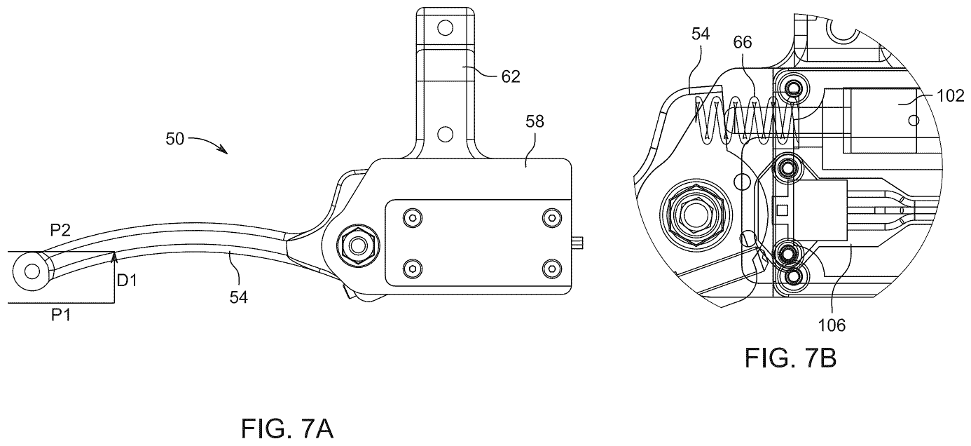

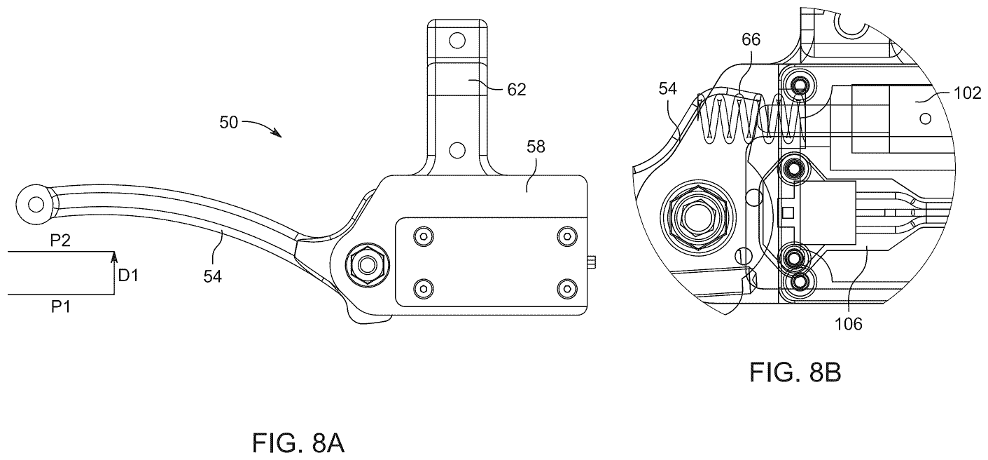

FIGS. 3-8B illustrate various views of the clutch input mechanism 50 according to some aspects. As shown in FIGS. 3-5, the clutch input mechanism 50 comprises a lever 54, a lever housing 58, a clamp 62, and a biasing member 66. FIGS. 6A-B illustrate a release position, where no force is applied to the clutch input mechanism 50 by the rider. In one embodiment (known as the dual-function embodiment), the clutch input mechanism 50 is configured to both function as a simulated clutch and to operate the brake assembly to slow the motorcycle 10. In the dual-function embodiment, the lever 54 of the clutch input mechanism 50 has a predetermined portion of a range of motion (defined by P1 and P2) in the engagement direction D1 (e.g., the initial 10% to the initial 25% of engagement of the lever 54 shown in FIGS. 7A-B) that may be used to activate the simulated clutch function. P1 defines a 0% engagement of the clutch and P2 defines a 100% engagement of the clutch. Once the portion of the range of motion defined by P1 and P2 are exceeded, the clutch input mechanism 50 transitions to operating the brake assembly (e.g., the subsequent 75% to 90% engagement action shown in FIGS. 8A-B). For example, this initial portion of the clutch input mechanism 50 may traditionally be considered “dead space” or non-responsive space in the motion of the lever 54 where braking is not yet applied until a larger degree of engagement (motion) is reached. As previously noted, the lever sensor 106 may be a potentiometer, a Hall sensor, or other sensor used to detect the position of the lever 54 in this dual-function embodiment.

In an alternate embodiment (also known as the dedicated embodiment), the clutch input mechanism 50 is configured to solely function as a clutch and the braking assembly is operated through a separate input mechanism (e.g., an additional lever assembly or a foot pedal, or elsewhere on the motorcycle 10). The clutch input mechanism 50 in the dedicated embodiment may include similar components as the clutch input mechanism 50 described above with respect to the dual-function embodiment. For example, the clutch input mechanism 50 may include the lever sensor 106 (e.g., a Hall effect sensor, a potentiometer, or other sensor) to detect the position of the lever 54. In either embodiment, a variable signal is provided to an ECU 200 (which may include an electronic speed controller (ESC)) from the lever sensor 106, wherein the signal represents the position of the lever 54 and can be used to control the simulated clutch function. It should be understood that although embodiments are described below with reference to the dedicated embodiment (where a lever position is represented as a variable signal representing a 0% engagement to a 100% engagement), the methods described herein may be used with either the separate, dedicated embodiment or the dual-function embodiment and, when the dual-function input mechanism is used, the predetermined motion of the clutch input mechanism 50 associated with a clutch function may be mapped to a value representing a 0% to 100% engagement or position and, thus, process similar to if a separate input mechanism for the clutch was used.

The lever 54 of the clutch input mechanism 50 is configured to be engaged by the rider and is rotatable about a lever axis Al defined by a lever fastener 70. The lever 54 comprises a plurality of magnet apertures 74 each configured to receive a magnet 78 (or a ferromagnetic member in alternate embodiments). Additionally, the lever 54 comprises a threaded aperture 82 configured to receive a set screw 86. The position of the set screw 86 is adjusted in the threaded aperture 82 to define a released position of the lever 54, when under no force from the rider. The lever 54 maintains a released position due to a biasing force applied by the biasing member 66.

The lever 54 is coupled to the lever housing 58 though the lever fastener 70. The lever housing 58 defines an interior volume, which is enclosed by a top lid 90 and a bottom lid 94 using a plurality of lid fasteners 96. Within the interior volume, the lever housing 58 defines a bore 98 containing a brake fluid (not shown) and a piston 102. As the lever 54 is rotated from the release position, the piston 102 moves further within the bore 98 and compresses the brake fluid. The compression of the brake fluid results in a proportional application of a braking force by the braking system. When the lever 54 is released, the biasing member 66 returns the lever 54 to the release position and the brake fluid moves the piston 102 outwardly. Furthermore, the lever sensor 106 is mounted to the bottom lid 94 and within the interior volume of the lever housing 58. In the illustrated embodiment, the lever sensor 106 is a Hall effect sensor configured to measure the position of the lever 54 using the magnets 78. Specifically, the lever sensor 106 measures the change in magnetic flux as magnets 78 of the lever 54 move with respect to the lever sensor 106. In other embodiments, the lever sensor 106 may be a potentiometer, a rotary encoder, an optical encoder, or another type of non-contact sensor.

Extending from a portion of the lever housing 58, the clamp 62 is configured to couple the clutch input mechanism 50 to the handlebars 22 of the motorcycle 10. Specifically, a portion of the handlebars 22 are inserted into the clamp opening 108. The rider can then position the clutch input mechanism 50 at a desired location. Once a desired location is set, a pair of clamping fasteners (not shown) are inserted into a set of clamping fastener apertures 112 and are installed. As the clamping fasteners are installed, the size of the clamp opening 108 is reduced and the clamp 62 applies a clamping force to reduce the likelihood that the clutch input mechanism is moved along the handlebars 22.

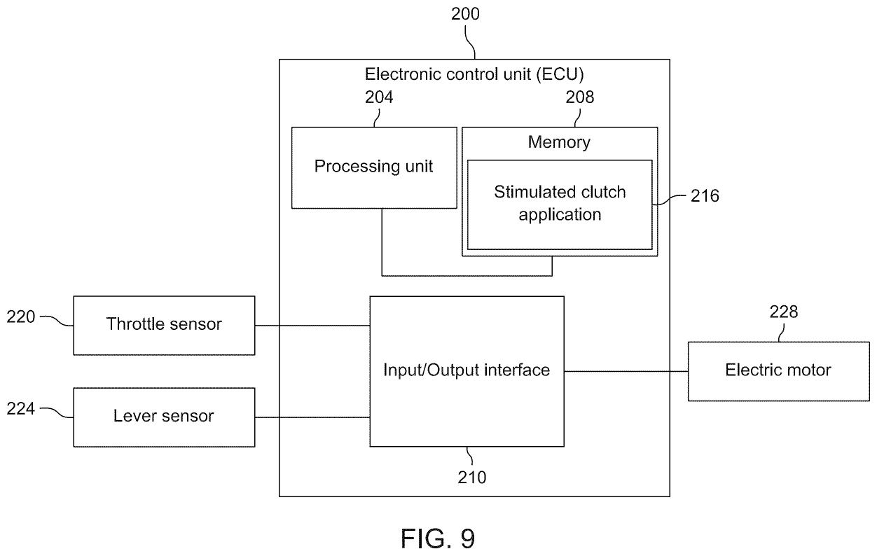

FIG. 9 schematically illustrates the ECU 200 of the motorcycle 10 according to some aspects. The ECU 200 may include additional components than those illustrated in FIG. 9 and may include components in various configurations. The particular set and configuration of components illustrated in FIG. 9 is provided as one non-limiting example. Also, functionality described herein as being performed via the ECU 200 may be distributed among multiple components of the motorcycle 10, such as, for example, among multiple ECUs.

As shown in FIG. 9, the ECU 200 includes a plurality of electrical and electronic components that provide power, operational control, and protection to the components within the ECU 200. As illustrated in FIG. 9, in some aspects, the ECU 200 includes an electronic processing unit 204 (for example, an electronic microprocessor, microcontroller, or similar device), a memory 208 (for example, non-transitory, computer-readable memory), and an input/output (I/O) interface 210. As noted above, the ECU 200 may include additional or alternative components, including additional electronic processors and memory, or application specific integrated circuits (ASICs), as well as one or more input devices, output devices, or a combination thereof. The components of the ECU 200 may be connected in various ways including, for example, a local bus.

The electronic processing unit 204 is communicatively coupled to the memory 208 and executes instructions stored on the memory 208. For example, in some aspects, the electronic processing unit 204 is configured to retrieve from the memory 208 and execute, among other things, instructions related to the control processes and methods described herein. For example, as illustrated in FIG. 9, the memory 208 may store a simulated clutch application 216 including executable instructions for performing the functionality described herein. The instructions and associated functionality as described herein may be combined and distributed in various ways and, in some aspects, functionality described herein as being performed via execution of the software application 216 may be distributed among fewer or additional modules. The memory 208 may also store data used by the application 216, such as, for example, one or more thresholds, offsets, one or more power curves, or one or more tables or data structures, or a combination thereof. These parameters may also be stored in other memory modules included in the motorcycle 10 that the ECU 200 has access to.

As illustrated in FIG. 9, the ECU 200 may communicate (through the I/O interface 210) with one or more input mechanisms from the motorcycle 10, such as, the throttle input mechanism 28 and the clutch input mechanism 50 or components thereof. For example, as illustrated in FIG. 9, the ECU 200 may communicate with a throttle sensor 220, a lever sensor 224, or a combination thereof, wherein such sensors provide a variable signal representing a detected position of the throttle input mechanism 28 and the clutch input mechanism 50. In some aspects, communication with a throttle sensor 220, a lever sensor 224, or a combination thereof may occur over a CAN bus of the motorcycle 10. However, in other aspects, different forms of communication may be used, and one or more intermediary components may process data between a data source and the ECU 200.

As illustrated in FIG. 9, the ECU 200 also communicates (e.g., via the I/O interface 2010) with the electric motor 228 included in the motorcycle 10. For example, in some embodiments, the ECU 200 outputs signals commanding a speed and torque from the electric motor 228 (which may be defined in terms of a speed, a torque, a level of power consumption, or a combination thereof) and, in some embodiments, may command a speed and torque from the electric motor 228 by controlling power delivery to the electric motor 228.

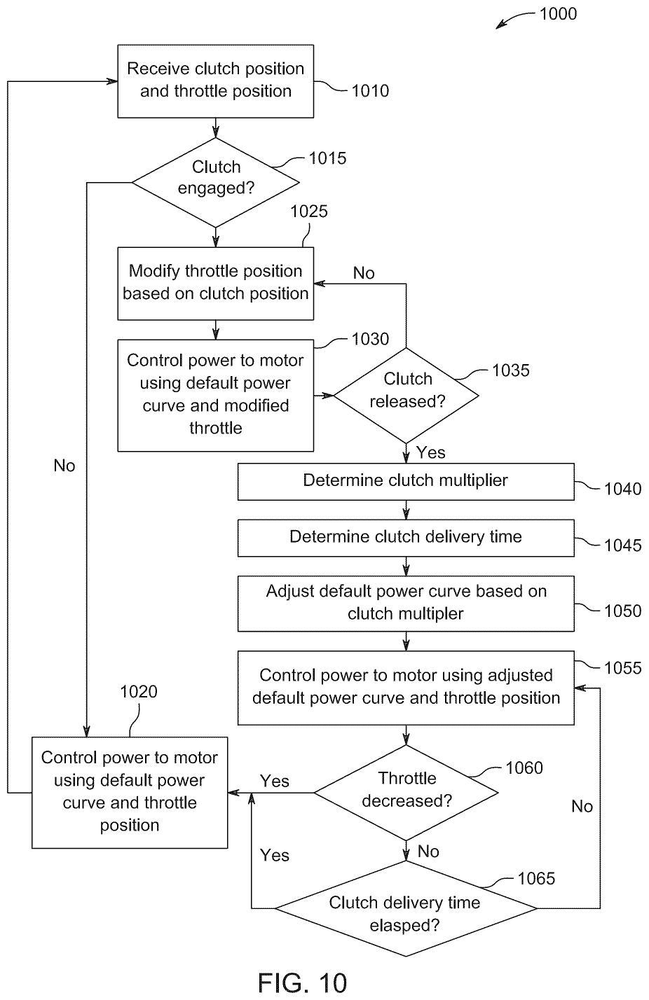

FIG. 10 is a flowchart illustrating a method 1000 for providing a simulated clutch to the electric motorcycle 10. The method is described as being performed via the ECU 200 (e.g., via execution of instructions, such as the simulation clutch application 316, via the electronic processing unit 204). However, it should be understood that the method 1000 or portions thereof may be performed by another controller or may be distributed over multiple controllers included in the motorcycle 10. As illustrated in FIG. 10, the method 1000 includes receiving, at the ECU 200, signals from one or more sensors representing a lever position and a throttle position (at block 1010). As noted above, in the dedicated embodiment, the lever position may be represented as a position between 0% (no engagement) and 100% (full engagement). In the dual-function embodiment, the lever position may be represented within a predetermined portion of a larger range of motion of the dual-function input mechanism (e.g., 0% to 10% or 0% to 25%) and, in some embodiments, the ECU 200 (or a separate controller) may map this position to a position between 0% and 100%. However, in other embodiments, the ECU 200 may use the lever position within the limited range to represent the lever position and, in such embodiments, the algorithm described herein may be adjusted to account for this distinction.

As illustrated in FIG. 10, the ECU 200 uses the received lever position (also known as a clutch position) to determine whether the clutch input mechanism 50 (also known as the simulated clutch) is engaged (in an engaged state) (at block 1015). In response to the clutch input mechanism 50 not being engaged (path “No” from block 1015), the ESC 212 of the ECU 200 controls power delivery to the motor 228 using a default power curve and the received throttle position (at block 1010). For example, the memory 208 of the ECU 200 may store or otherwise have access to a default power curve that may associate a particular throttle position (e.g., represented as a position between 0% and 100%) with a particular power output of the motor 228 (or desired motor output).

Alternatively, in response to the clutch input mechanism 50 being engaged (path “Yes” from block 1015), the ECU 200 modifies the throttle position based on the lever position to, for example, reduce the power output of the motor 228 (blocks 1025 and 1030). For example, as described above, in ICE vehicles, engaging the clutch disengages the engine from the transmission and effectively cuts power. Accordingly, to simulate such a clutch function, the ESC 212 may be configured to reduce the power output of the motor 228 when the clutch input mechanism 50 is engaged. In some embodiments, the throttle position is variably reduced based the lever position. For example, if the lever is engaged at 55%, the throttle position may be reduced by 55%. However, it should be understood that other ways to modify and effectively reduce power output may be used by the ESC 212. For example, in some embodiments, rather than modifying the throttle position, the ECU 200 may modify the default power curve or access and use a power curve associated with clutch engagement.

As illustrated in FIG. 10, this reduced power output is continued until the lever 54 is released (path “No” from block 1035). It should be understood that if the throttle position is changed while the lever 54 is engaged, the new throttle position may be used at blocks 1025 and 1030.

When the lever 54 is released (path “Yes” from block 1035), the ECU 200 commands the ESC 212 to provide a power boost to simulate a clutch release on an ICE vehicle. In some embodiments, the power boost varies in terms of amount, delivery time, a combination thereof based on the amount of lever engagement, the release rate of the lever 54 (e.g., how quickly or slowly the lever 54 was released from an engaged position (100%) to a disengaged position (0%), or a combination thereof.

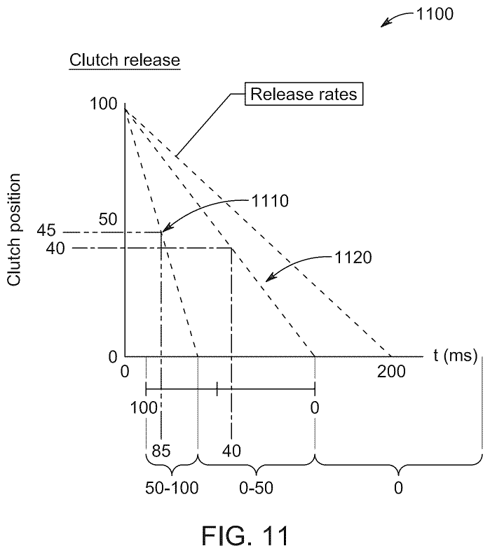

For example, to provide the power boost, the ECU 200 determines a clutch multiplier (at block 1040) and determines a clutch delivery time (at block 1045). The clutch multiplier may be based on how much the lever 54 was engaged (e.g., a maximum position of the lever 54 before being released, how quickly the lever 54 is released from an engaged state (FIGS. 7A-B), or a combination thereof. As one non-limiting example, the ECU 200 may determine the clutch multiplier by multiplying a lever position (e.g., in the 0% to 100% range), which may represent a maximum position or engagement of the clutch input mechanism 50 prior to a release, by a time value (e.g., in milliseconds) representing how long the lever 54 was engaged before it was fully released, and dividing the product by 1000 to obtain an adjustment percentage or boost that is applied to the default power curve. For example, FIG. 11 illustrates a clutch release chart 1100, wherein the x-axis represent time (e.g., in milliseconds) after a clutch engagement and the y-axis represents a clutch position. In the chart 1100, two different example clutch engagements 1110 and 1120 are illustrated. The first example 1110 represents a clutch engagement where the clutch was engaged at 45% and was released approximately 15 milliseconds later. The second example 1120 represents a clutch engagement where the clutch was engaged at 40% and was released approximately 60 milliseconds later.

Accordingly, using the example algorithm described above, a higher engagement (i.e., closer to 100% or P2 in FIG. 7A) of the lever 54 will results in a larger boost (higher adjustment) than a lower engagement (i.e., closer to 0% or P1 in FIG. 6A). Also, to have a quicker release result in a larger boost (higher adjustment) than a slow release, the time the lever 54 was engaged can be translated to a representative time value that is effectively the inverse of the engagement time. In other words, the longer the lever 54 was engaged, the lower the time value used in the algorithm and the lower (smaller) the adjustment. For example, as one example illustrated in FIG. 11, clutch releases occurring after approximately 25 milliseconds to 50 milliseconds may be considered “fast” releases and, thus, to create an appropriate boost, these release times may be translated to a representative time value between 100 and 50. Similarly, clutch releases occurring between 50 milliseconds and 125 milliseconds may be considered “slow” releases and, thus, to create an appropriate boost, these release times may be translated to a representative time value greater than 0 but less or equal to 50. As also illustrated in FIG. 11, clutch releases occurring after 125 milliseconds may be considered very “slow” releases wherein no boost should be applied and, thus, the representative time value may be set to 0. In some embodiments, a simple inverse equation may be used to translate a release time to a representative time value for the multiplier algorithm. For example, the release time may be subtracted from 100 (plus or minus some offset value) to obtain the representative time value for the multiplier algorithm. Other rules or logic may similarly be applied, such as, for example, comparing a release time to various buckets or ranges of times associated with a particular representative time value.

For example, assuming that the representative time value in example 1 is 85 and the representative time value in example 2 is 40, the clutch multiplier for example 1 may be 3.825% (45*85/1000) and the clutch multiplier for example may be 1.6% (40*40/1000).

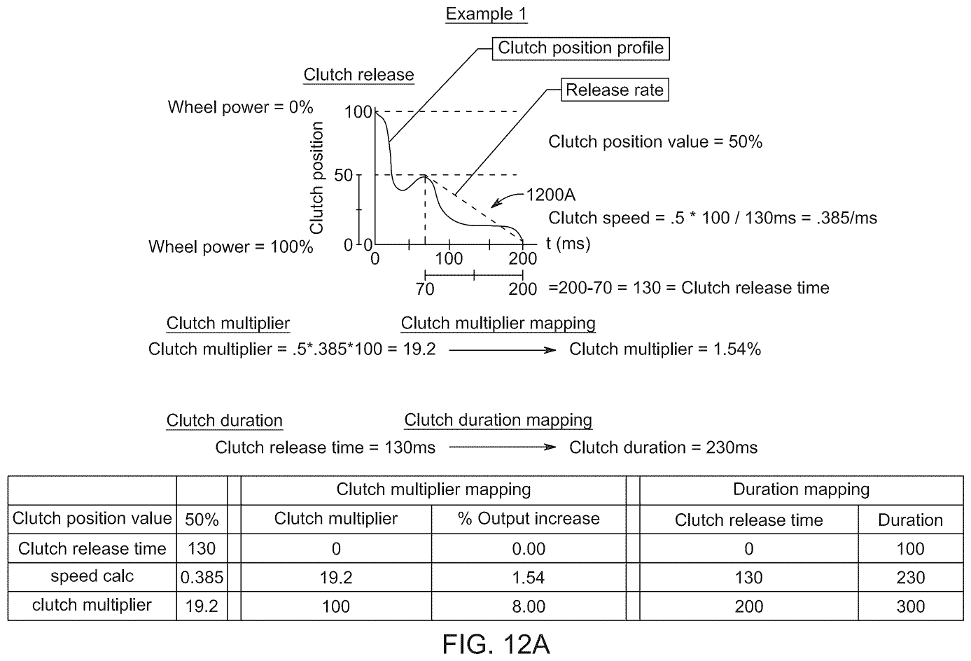

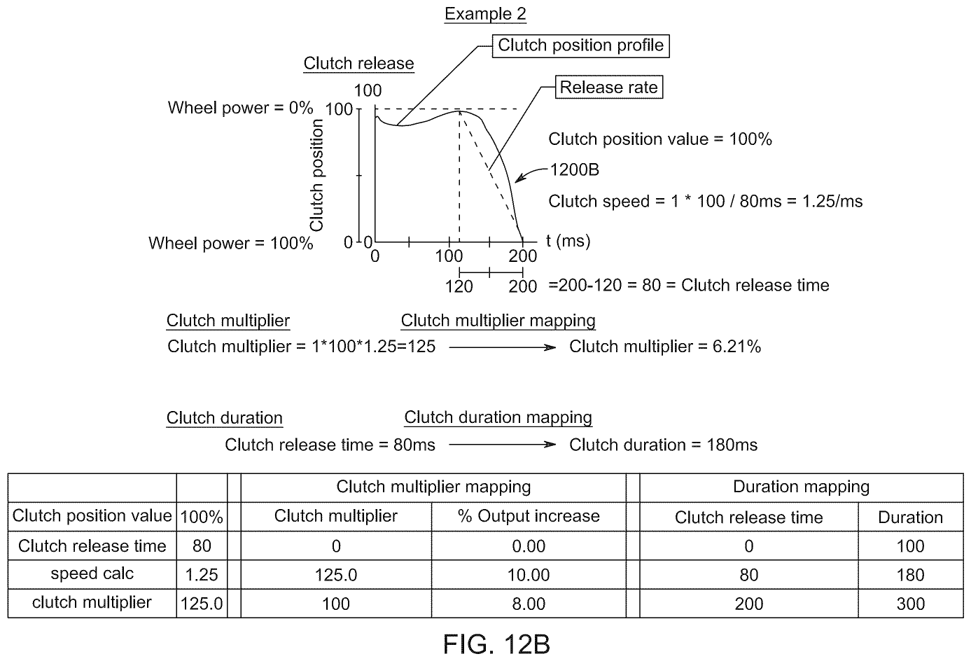

It should be understood that the algorithms used with the example illustrated in FIG. 11 represent one possible configuration to determining a clutch multiplier and other algorithms may be used. For example, in another embodiment, the clutch multiplier may be based on how much (e.g., the percentage or degree) the lever 54 was engaged, how quickly the lever 54 is released from an engaged state (FIGS. 7A-B), or a combination thereof. As one non-limiting example, the ECU 200 may determine the clutch multiplier by multiplying a lever position (e.g., in the 0% to 100% range), by a clutch speed (e.g., change in lever position per millisecond), which may represent a rate of release of the lever 54. For example, FIGS. 12A-B illustrate a clutch release chart 1200A, 1200B, wherein the x-axis represents time (e.g., in milliseconds (“ms”)) after a clutch engagement and the y-axis represents a clutch position. In chart 1200A, a first clutch engagement example is illustrated where the clutch was engaged at 100% and was fully released approximately 80 ms later. In chart 1200B, a second clutch engagement example is illustrated where the clutch was engaged at 50% and was released approximately 130 ms later.

Accordingly, as illustrated in FIG. 12A and 12B, a higher engagement (i.e., closer to 100%) of the lever 54 results in a larger boost (higher adjustment) than a lower engagement (i.e., closer to 0%). Also, a quicker release of the lever 54 results in a larger boost (higher adjustment) than a slower release, as the lower release time will result in a higher clutch speed (change in lever position divided by time elapsed before full release). In the example of FIGS. 12A and 12B, both the lever engagement value and the clutch speed have a direct relationship with the clutch multiplier. For example, assuming that the release time in the example shown in FIG. 12A is 80 ms and the maximum lever engagement was 100%, the preliminary clutch multiplier for the example shown in FIG. 12A is 125 (1*100*(1/80)*100). This preliminary clutch multiplier can be mapped to a final clutch multiplier, which may be more representative of an ICE motorcycle. In some embodiments, linear interpolation may be used to create mappings correlating the position and speed of the clutch to produce a “feeling” similar to an ICE clutch. In some embodiments, this mapping may take into account a throttle position and a variance of such position from a target motor speed versus what the motor speed is when the clutch is released.

After the mapping, the clutch multiplier for the example shown in FIG. 12A is 10% (representing a 10% output increase). For the example shown in FIG. 12B, the preliminary clutch multiplier is 19.25 (0.5*100*(0.5/130)*100), and after mapping, the final clutch multiplier is 1.54%.

In some embodiments, the clutch delivery time, which represents how long the boost is applied, may be determined based on the clutch multiplier. For example, in some embodiments, the clutch delivery time may be determined by multiplying the clutch multiplier by the maximum lever position/engagement (with the optional application of an offset (e.g., multiplied or added to the resulting value), wherein the resulting value is used as defining a time in milliseconds. For example, using the clutch multipliers provided above for example 1 and example 2 in FIG. 11, the clutch delivery time for example 1 may be 172.125 milliseconds (3.825*45) and the clutch delivery time for example 2 may be 64 milliseconds (1.6*40).

Again, it should be understood that the algorithms used with the example illustrated in FIG. 11 represent one possible configuration to determining a clutch delivery time and other algorithms may be used. For example, in another embodiment, the clutch delivery time may be determined based on the release time, where a faster release time would result in a smaller clutch delivery time. For example, in some embodiments, the clutch delivery time is determined by mapping the clutch release time to a duration, which may be used to set the clutch delivery time to a value within a minimum and a maximum clutch delivery time. For the example shown in FIG. 12A, the clutch release time is 80 ms, which may be mapped to a clutch delivery time of 180 ms. For the example shown in FIG. 12B, the clutch release time is 130 ms, which may be mapped to a clutch delivery time of 230 ms. In some embodiments, the clutch delivery time may also be influenced by the clutch multiplier. Specifically, if the calculated clutch multiplier exceeds a maximum clutch multiplier, the clutch delivery time may be further increased proportionally to the difference between the maximum clutch multiplier and the calculated clutch multiplier. In some embodiments, the mapping of the clutch release time to the clutch delivery time may be performed using linear interpolation, one or more predetermined offsets, or the like.

As illustrated in FIGS. 12A and 12B, the quicker the clutch release, the shorter the power boost duration. However, it should be understood that the ECU 200 may be programmed to use various algorithms in determining clutch delivery time and may be programmed to provide various types of simulated clutch behavior. For example, in other embodiments, the ECU 200 may be configured such that, the quicker the release of the clutch, the clutch delivery time (length of power) may grow (e.g., if the motor cannot generate the increased % of output).

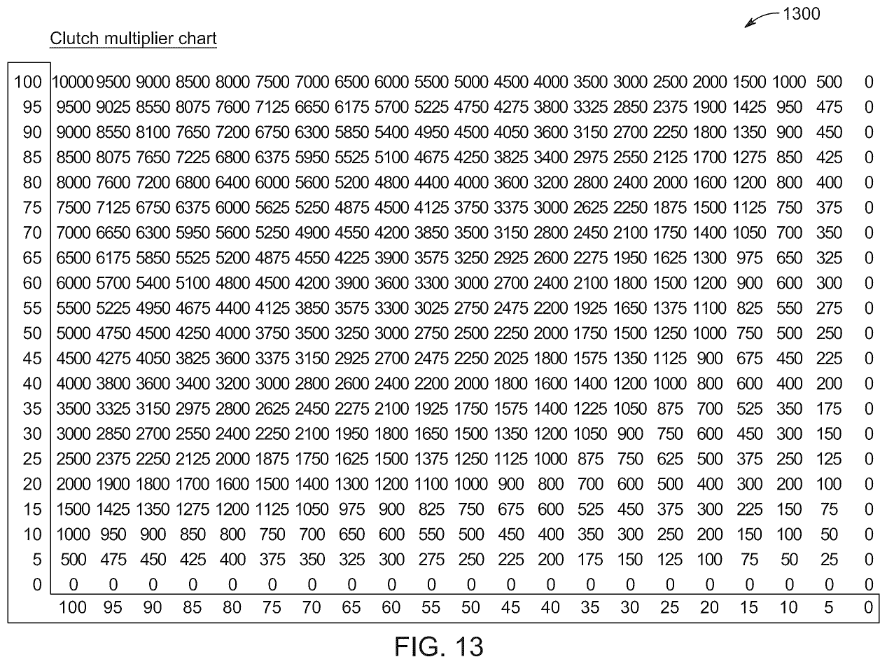

It should be understood that the ECU 200 may determine the clutch multiplier and/or the clutch delivery time using programmed equations. Alternatively, the ECU 200 may access various charts or tables to determine these values, such as, for example, a clutch multiplier chart 1300 as illustrated in FIG. 13.

Returning to FIG. 10, the ECU 200 adjusts the default power curve based on the clutch multiplier (e.g., increasing the power output defined by the default power curve) (at block 1050) and controls the motor 228 using the adjusted power curve (at block 1055). It should be understood that if the throttle position is increased while the adjusted power curve is being applied, the new throttle position may be used at blocks 1050 and 1055 and the adjusted power curve may continue to be applied (a power boost is applied) (path “No” from block 1060) until the clutch delivery time elapses (path “Yes” from block 1065). In response to the clutch delivery time elapsing (which the ECU 200 may track using a timer, counter, or similar mechanism), the ESC 212 may stop applying the adjusted power curve (i.e., return to controlling the motor 228 using the default power curve) (at block 1020).

Similarly, in response to the ECU 200 receiving a new throttle position representing a decrease in throttle (“Yes” path from block 1060) while the power boost is being applied, the ESC 212 may stop applying the adjusted power curve (i.e., return to controlling the motor 228 using the default power curve) regardless of whether the clutch delivery time has elapsed (at block 1020). For example, a rider who decide that the power boost is not needed or desired, may use a throttle decrease to effectively cancel the power boost provided via the simulated clutch.

It should be understood that when the power boost is ended (e.g., either due to elapsing of the clutch delivery time or a throttle decrease), the power boost may be ended immediately or may be phased out over a period of time (e.g., to prevent drastic changes in power).

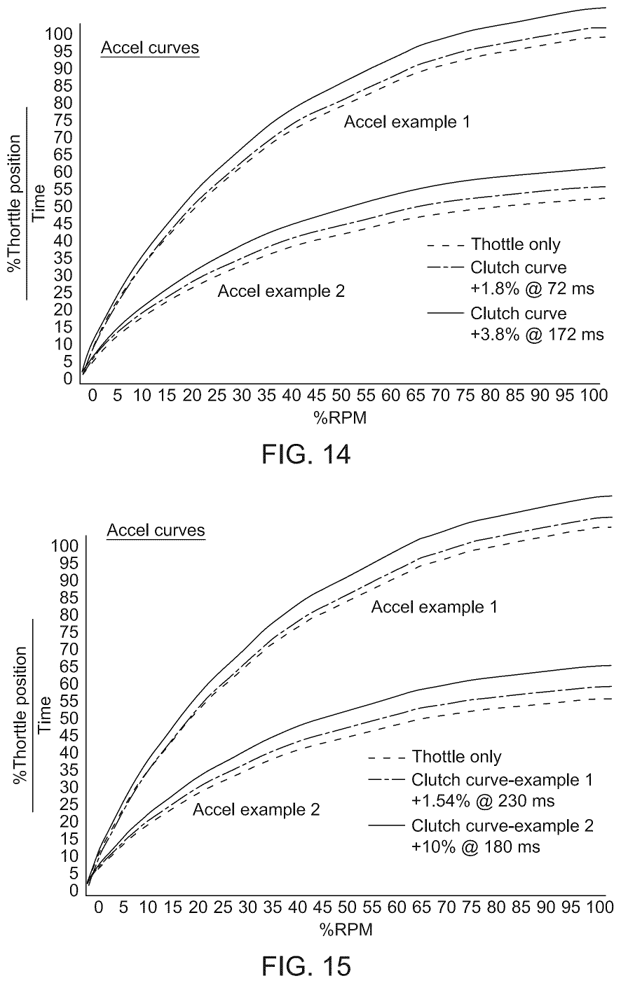

FIG. 14 illustrates two example acceleration examples and, in particular, for each example, illustrates acceleration resulting from a change in throttle position (no simulated clutch engagement) as well as acceleration resulting from a change in throttle position combined with a clutch power boost, such as, for example, a power boost based on the two example clutch engagements as represented in FIG. 11.

FIG. 15 illustrates two additional example acceleration examples and, in particular, for each example, illustrates acceleration resulting from a change in throttle position (no simulated clutch engagement) as well as acceleration resulting from a change in throttle position combined with a clutch power boost, such as, for example, a power boost based on the two example clutch engagements as represented in FIG. 12A and FIG. 12B.

In some embodiments, various overrides may be applied by the ECU (or a separate controller) for the simulated clutch. For example, the simulated clutch functionality described herein may be overridden (e.g., ignored such that default power output is applied) or modified (e.g., reduced boost) based on one or more characteristics of a battery supplying power to the motor 228 (e.g., state of charge, temperature, etc.). Similarly, a fail-safe mechanism may be employed to revert to a default power output level (i.e., a default power curve) in response to detect a sensor failure or other malfunction.

Thus, embodiments described herein provides methods and systems for providing a simulated clutch for an electric vehicle, such as, for example, an electric motorcycle. A clutch input mechanism, which may include various types of input mechanisms and is not limited to use of a lever or similar pivoting biased member or actuator, is mounted on the vehicle (e.g., on a portion of the handlebars), wherein the amount and speed at which the clutch input mechanism 50 is engaged may impact simulated resulting clutch function. For example, as described herein, engagement of the simulated clutch (e.g., through engagement of the clutch input mechanism) may cause a reduction to power provided to the electric motor (to reduce torque output of the motor) to mimic a clutch engagement on an ICE vehicle. Similarly, when the simulated clutch is released (i.e., no longer engaged), a power boost may be provided via the electronic motor to mimic a clutch release on an ICE vehicle. The amount and duration of the power boost may be based on the amount of engagement of the clutch and the speed at which the clutch was released. In other words, activation of the clutch input mechanism controls (electronically) power provided to the drivetrain (e.g., the electric motor) to mimic a response of using a clutch on an ICE motorcycle. Controlling the power delivery proportionally based on how and how long the clutch input mechanism is engaged provides a rider with enhanced control of the vehicle. For example, as one non-limiting example of such enhanced control, the clutch input mechanism may be used to perform a motocross start with the motorcycle 10. In a motocross start, the rider engages the clutch input mechanism before engaging the throttle input mechanism. Then, the rider simultaneously releases the clutch input mechanism and engages the throttle input mechanism to move the motorcycle 10 at a higher velocity than solely engaging the throttle input mechanism. In some embodiments, when the motorcycle 10 is at 0 mph, engagement of the clutch without throttle activation may not result in movement of the motorcycle 10 and the rider would need to use the above-described motocross start process to use the clutch to get the motorcycle 10 moving.

What is claimed is:

1. A system for providing a simulated clutch function for an electric vehicle, the system comprising:
a clutch input mechanism;
one or more sensors providing signals representing a position of the clutch input mechanism; and
a controller, the controller configured to:
based on the signals from the one or more sensors, determine whether the clutch input mechanism has been released from an engaged state, and
in response to determining that the clutch input mechanism has been released from the engaged state:
determine a clutch multiplier,
determine a clutch delivery time, and
adjust a power curve mapping the position of a throttle mechanism to a power output based on the clutch multiplier and control power to a motor based on a position of a throttle input mechanism and the adjusted power curve for the clutch delivery time.

2. The system of claim 1, wherein the clutch input mechanism is integrated into a brake input mechanism.

3. The system of claim 1, wherein the controller is further configured to:
determine, based on the signals from the one or more sensors, whether the clutch input mechanism is in the engaged state; and
in response to determining that the clutch input mechanism is in the engaged state, control power to the motor to reduce output of the motor while the clutch input mechanism is in the engaged state.

4. The system of claim 3, wherein the controller is configured to determine whether the clutch input mechanism is in the engaged state by determining whether the clutch input mechanism is positioned within a predetermined range of a brake input mechanism.

5. The system of claim 3, wherein the controller is configured to control power to the motor to reduce the output of the motor by reducing a position of a throttle input mechanism based on the position of the clutch input mechanism.

6. The system of claim 1, wherein the controller is configured to determine the clutch multiplier based on the position of the clutch input mechanism when in the engaged state and how long the clutch input mechanism was in the engaged state before being released.

7. The system of claim 1, wherein the controller is configured to determine the clutch multiplier by multiplying a maximum position of the clutch input mechanism when in the engaged state and a time value representing how long the clutch input mechanism was in the engaged state before being released, wherein the longer the clutch input mechanism was in the engaged state before being released, the lower the time value.

8. The system of claim 1, wherein the controller is configured to determine the clutch delivery time based on the position of the clutch input mechanism when in the engaged state and how long the clutch input mechanism was in the engaged state before being released.

9. The system of claim 1, wherein the controller is configured to determine the clutch delivery time by multiplying the clutch multiplier and a time value representing how long the clutch input mechanism was in the engaged state before being released, wherein the longer the clutch input mechanism was in the engaged state before being released, the lower the time value.

10. The system of claim 1, wherein the controller is further configured, in response to determining that the position of the throttle input mechanism decreased while power to the motor is controlled based on the adjusted power curve, control power to the motor based on the power curve regardless of whether the clutch delivery time has elapsed.

11. The system of claim 1, wherein the one or more sensors including one or more of a group consisting of a potentiometer and a Hall effect sensor.

12. A method of providing a simulated clutch function for an electric vehicle, the method comprising:
receiving, by a controller, signals representing a position of a clutch input mechanism positioned on the electric vehicle;
determining, by the controller based on the signals, whether the clutch input mechanism has been released from an engaged state; and
in response to determining that the clutch input mechanism has been released from the engaged state:
determining, by the controller, a clutch multiplier,
determining, by the controller, a clutch delivery time, and
adjusting, by the controller, a power curve mapping the position of a throttle mechanism to a power output based on the clutch multiplier and control power to a motor based on a position of a throttle input mechanism and the adjusted power curve for the clutch delivery time.

13. The method of claim 12, further comprising:
determining, by the controller based on the signals, whether the clutch input mechanism is in the engaged state; and
in response to determining that the clutch input mechanism is in the engaged state, controlling power, by the controller, to the motor to reduce output of the motor while the clutch input mechanism is in the engaged state.

14. The method of claim 13, wherein determining whether the clutch input mechanism is in the engaged state includes determining whether the clutch input mechanism is positioned within a predetermined range of a brake input mechanism.

15. The method of claim 13, wherein controlling the power to the motor to reduce the output of the motor includes reducing a position of a throttle input mechanism based on the position of the clutch input mechanism.

16. The method of claim 12, wherein determining the clutch multiplier includes determining the clutch multiplier based on the position of the clutch input mechanism when in the engaged state and how long the clutch input mechanism was in the engaged state before being released.

17. The method of claim 12, wherein determining the clutch multiplier includes multiplying a maximum position of the clutch input mechanism when in the engaged state and a time value representing how long the clutch input mechanism was in the engaged state before being released, wherein the longer the clutch input mechanism was in the engaged state before being released, the lower the time value.

18. The method of claim 12, wherein determining the clutch delivery time includes determining the clutch delivery time based on the position of the clutch input mechanism when in the engaged state and how long the clutch input mechanism was in the engaged state before being released.

19. The method of claim 12, wherein determining the clutch delivery time includes multiplying the clutch multiplier and a time value representing how long the clutch input mechanism was in the engaged state before being released, wherein the longer the clutch input mechanism was in the engaged state before being released, the lower the time value.

20. The method of claim 12, further comprising, in response to determining that the position of the throttle input mechanism decreased while power to the motor is controlled based on the adjusted power curve, controlling power, by the controller, to the motor based on the power curve regardless of whether the clutch delivery time has elapsed.
